(19) United States
(12) Patent Application Publication
(10) Pub. No.: US 2025/0028148 A1
(43) Pub. Date: Jan. 23, 2025

(54) OPTICAL ELEMENT DRIVING MECHANISM

(71) Applicant: TDK TAIWAN CORP., Taoyuan City (TW)

(72) Inventors: Ya-Hsiu WU, Taoyuan City (TW); Kai-Po FAN, Taoyuan City (TW); Ying-Jen WANG, Taoyuan City (TW); Sin-Jhong SONG, Taoyuan City (TW)

(21) Appl. No.: 18/778,550

(22) Filed: Jul. 19, 2024

Related U.S. Application Data
(60) Provisional application No. 63/514,958, filed on Jul. 21, 2023.

(51) Int. Cl. G02B 7/08; G02B 27/64

(52) U.S. Cl. CPC G02B 7/08; G02B 27/646

(57) ABSTRACT

An optical element driving mechanism is provided, which includes a fixed portion, a first movable portion, and a driving assembly. The first movable portion is used for connecting to a first optical element. The first movable portion is movable relative to the fixed portion. The first driving assembly is used for driving the first movable portion to move relative to the fixed portion.

### CROSS REFERENCE TO RELATED APPLICATIONS

This application claims priority of U.S. Provisional Patent Application No. 63/514,958 filed on Jul. 21, 2023, the entirety of which is incorporated by reference herein.

### BACKGROUND OF THE INVENTION

### Field of the Invention

The present disclosure relates to an optical element driving mechanism.

### Description of the Related Art

As technology has developed, it has become more common to include image-capturing and video-recording functions into many types of modern electronic devices, such as smartphones and digital cameras. These electronic devices are used more and more often, and new models have been developed that are convenient, thin, and lightweight, offering more choice to consumers.

Electronic devices that have image-capturing or video-recording functions normally include a driving mechanism to drive an optical element (such as a lens) to move along its optical axis, thereby achieving auto focus (AF) or optical image stabilization (OIS). Light may pass through the optical element and may form an image on an optical sensor. However, the trend in modern mobile devices is to have a smaller size and a higher durability. As a result, how to effectively reduce the size of the optical system and how to increase its durability has become an important issue.

### BRIEF SUMMARY OF THE INVENTION

An optical element driving mechanism is provided, which includes a fixed portion, a first movable portion, and a driving assembly. The first movable portion is used for connecting to a first optical element. The first movable portion is movable relative to the fixed portion. The first driving assembly is used for driving the first movable portion to move relative to the fixed portion.

In some embodiments, the optical element driving mechanism further includes a connecting assembly. The fixed portion includes a bottom. The bottom includes a first recessed portion, a second recessed portion, and a first bottom surface. The first recessed portion and the second recessed portion are recessed from the first bottom surface. The first recessed portion includes a first recessed portion bottom surface. The second recessed portion includes a second recessed portion bottom surface. The second recessed portion surrounds the first recessed portion. The first recessed portion surface and the second recessed portion surface are parallel. The first bottom surface and the second recessed portion surface are parallel. A gap is between the first bottom surface and the second recessed portion surface. The gap is less than 0.1 mm.

In some embodiments, the first recessed portion further includes a first side surface and a second side surface. The first side surface and the second side surface are not parallel. The first side surface and the first recessed portion bottom surface are not parallel. The second side surface and the first recessed portion bottom surface are not parallel.

In some embodiments, the connecting assembly includes a first connecting element. The first movable portion includes a third recessed portion. The first connecting element is disposed in the first recessed portion and the third recessed portion. The third recessed portion includes a third recessed portion bottom surface. The third recessed portion bottom surface is parallel to the first recessed portion bottom surface. The first connecting element is in direct contact with the first side surface, the second side surface, and the third recessed portion bottom surface. The first connecting element and the first recessed portion bottom surface are separated from each other.

In some embodiments, the first movable portion further includes a fourth recessed portion, a fifth recessed portion, and a first recessed structure. The connecting assembly further includes a second connecting element and a third connecting element. The bottom further includes a sixth recessed portion and a seventh recessed portion. The second connecting element is disposed in the fourth recessed portion and the sixth recessed portion. The third connecting element is disposed in the fifth recessed portion and the seventh recessed portion.

In some embodiments, the optical element driving mechanism further includes a first sensing element and an auxiliary magnetic element disposed on the fixed portion. A distance between the first sensing element and the fourth recessed portion is less than a distance between the first sensing element and the third recessed portion. A distance between the auxiliary magnetic element and the fourth recessed portion is less than a distance between the auxiliary magnetic element and the third recessed portion.

In some embodiments, the fixed portion further includes a case. The case includes an opening. The optical element driving mechanism further includes a second movable portion, a resilient element, a first buffer element, and a second buffer element. The resilient element is disposed between the fixed portion and the second movable portion. The first buffer element is disposed between the fixed portion and the second movable portion. The second buffer element is disposed between the fixed portion and the first movable portion.

In some embodiments, the first movable portion and the second movable portion are arranged along a first axis. A second axis is perpendicular to the first axis. The resilient element and the first buffer element at least partially overlap each other in a direction that the second axis extends. The first recessed structure and the third recessed portion at least partially overlap each other in the direction that the second axis extends. The resilient element and the first buffer element do not overlap each other when viewed along the first axis. The resilient element and the second buffer element at least partially overlap each other in a direction that the first axis extends.

In some embodiments, the second movable portion is used for connecting a second optical element. The second movable portion includes a main body and a first sidewall. The sidewall extends from the main body. The first sidewall includes a first recess, a second recess, and a first supporting portion. The first recess is adjacent to the second recess. The first recess includes a first recess surface. The second recess includes a second recess surface. The first recess surface is adjacent to the second recess surface. The first recess surface and the second recess surface are not parallel.

In some embodiments, the first recess surface and the second recess surface have different slopes. The first supporting portion extends from the first sidewall along a third axis. The third axis is not parallel to the first axis. The third axis is not parallel to the second axis.

In some embodiments, the main body includes a main body surface, a second supporting portion, and a third supporting portion. The main body surface faces the second optical element. The second supporting portion extends from the main body surface. The third supporting portion extends from the main body surface. The second supporting portion extends along the third axis. The third supporting portion extends along the third axis.

In some embodiments, the second supporting portion is at a first side of the main body surface. The third supporting portion is at a second side of the main body surface. The first side and the second side are opposite. The third axis is perpendicular to the first axis. The third axis is perpendicular to the second axis.

In some embodiments, the fixed portion further includes a first reinforcement element and a second reinforcement element disposed on the bottom. The bottom further includes a second bottom surface. The first reinforcement element includes a first reinforcement element surface. The second reinforcement element includes a second reinforcement element surface. The first reinforcement element surface is parallel to the second reinforcement element surface. The first reinforcement element surface is parallel to the second bottom surface.

In some embodiments, a first height difference is between the second bottom surface and the second reinforcement element surface in the direction that the second axis extends. A second height difference is between the first reinforcement element surface and the second reinforcement element surface in the direction that the second axis extends. The first height difference and the second height difference are greater than zero. The second reinforcement element surface is between the second bottom surface and the first reinforcement element surface. The second supporting portion is at a middle section of the first side.

In some embodiments, the optical element driving mechanism further includes a second sensing element. The second sensing element and the first reinforcement at least partially overlap each other in the direction that the second axis extends. Materials of the first reinforcement element and the second reinforcement element are different. Magnetic permeability coefficients of the first reinforcement element and the second reinforcement element are different.

In some embodiments, the first reinforcement element has a first thickness. The second reinforcement element has a second thickness. The first thickness and the second thickness are different. The first reinforcement element and the second reinforcement element do not overlap each other when viewed along the second axis. The second reinforcement element is welded to the case.

In some embodiments, the optical element driving mechanism further includes a circuit element and a first adhesive element, the circuit element includes a first circuit element surface and a second circuit element surface. The first circuit element surface is in direct contact with the first reinforcement element and the second reinforcement element. The second circuit element surface is in direct contact with the bottom. The first circuit element surface and the second circuit element surface are opposite. The first adhesive element is disposed on the first circuit element surface and the second circuit element surface. The magnetic permeability coefficient of the first reinforcement element is greater than the magnetic permeability coefficient of the second reinforcement element. The first thickness is less than the second thickness.

In some embodiments, the bottom includes a second recessed structure, a first positioning element, a second positioning element, and a third positioning element. The optical element driving mechanism further includes a second adhesive element and a third adhesive element. The second adhesive element is disposed between the bottom and the circuit element. The third adhesive element is disposed in the second recessed structure. The third adhesive element is in direct contact with the first positioning element. The third adhesive element is in direct contact with the second positioning element. The third adhesive element is in direct contact with the third positioning element. The third adhesive element is in direct contact with the second adhesive element.

In some embodiments, the circuit element does not overlap the first positioning element, the second positioning element, and the third positioning element when viewed along the third axis. The case does not overlap the first positioning element and the second positioning element when viewed along the third axis. The case at least partially overlaps the third positioning element when viewed along the third axis. The bottom further includes a protruding portion exposed from the case when viewed along the first axis. The protruding portion includes a first protruding portion surface and a second protruding portion surface, and the first protruding portion surface and the second protruding portion surface are exposed from the case. Slopes of the first protruding portion surface and the second protruding portion surface are different.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1A is a schematic view of the optical element driving mechanism.

FIG. 1B is an exploded view of the optical element driving mechanism.

FIG. 1C is a top view of the optical element driving mechanism.

FIG. 1D is a side view of the optical element driving mechanism.

FIG. 1E is a schematic view of the optical element driving mechanism.

FIG. 2A is a cross-sectional view along a line A-A of FIG. 1C.

FIG. 2B is an enlarged view of an area in FIG. 2A.

FIG. 2C is a cross-sectional view along a line B-B of FIG. 1C.

FIG. 2D is an enlarged view of an area in FIG. 2C.

FIG. 2E is an enlarged view of an area in FIG. 2C.

FIG. 2F is a cross-sectional view along a line C-C of FIG. 1C.

FIG. 2G is a cross-sectional view along a line D-D of FIG. 1C.

FIG. 2H is a cross-sectional view along a line E-E of FIG. 1C.

FIG. 3 is a schematic view of some elements of the optical element driving mechanism.

FIG. 4 is a schematic view of some elements of the optical element driving mechanism.

FIG. 5A and FIG. 5B are schematic views of the second movable portion and the second optical element viewed from different directions.

FIG. 5C is a cross-sectional view along a line F-F in FIG. 5B.

FIG. 6A is a bottom view of the optical element driving mechanism.

FIG. 6B is a cross-sectional view along a line G-G of FIG. 6A.

FIG. 6C is an enlarged view of an area in FIG. 6B.

FIG. 7 is a bottom view of the optical element driving mechanism in another embodiment of the present disclosure.

FIG. 8A, FIG. 8B, and FIG. 8C are schematic views of some elements of the optical element driving mechanism.

### DETAILED DESCRIPTION OF THE INVENTION

The following disclosure provides many different embodiments, or examples, for implementing different features of the provided subject matter. Specific examples of elements and arrangements are described below to simplify the present disclosure. These are, of course, merely examples and are not intended to be limiting. For example, in some embodiments, the formation of a first feature over or on a second feature in the description that follows may include embodiments in which the first and second features are in direct contact, and may further include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may further include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

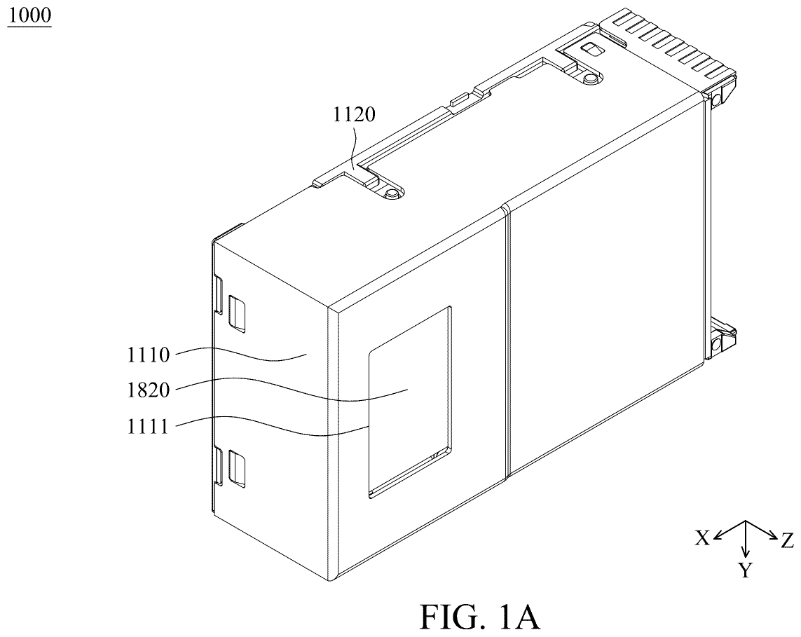

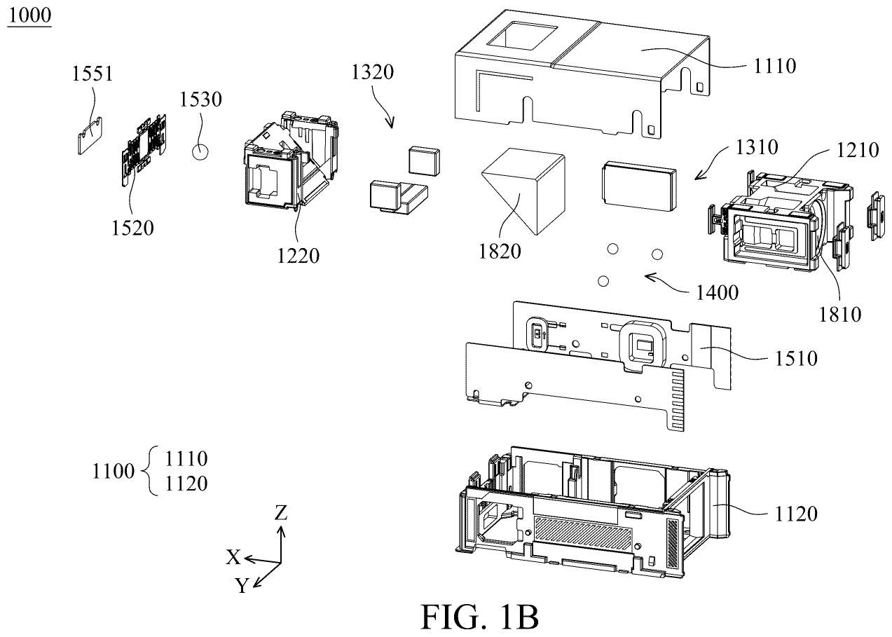

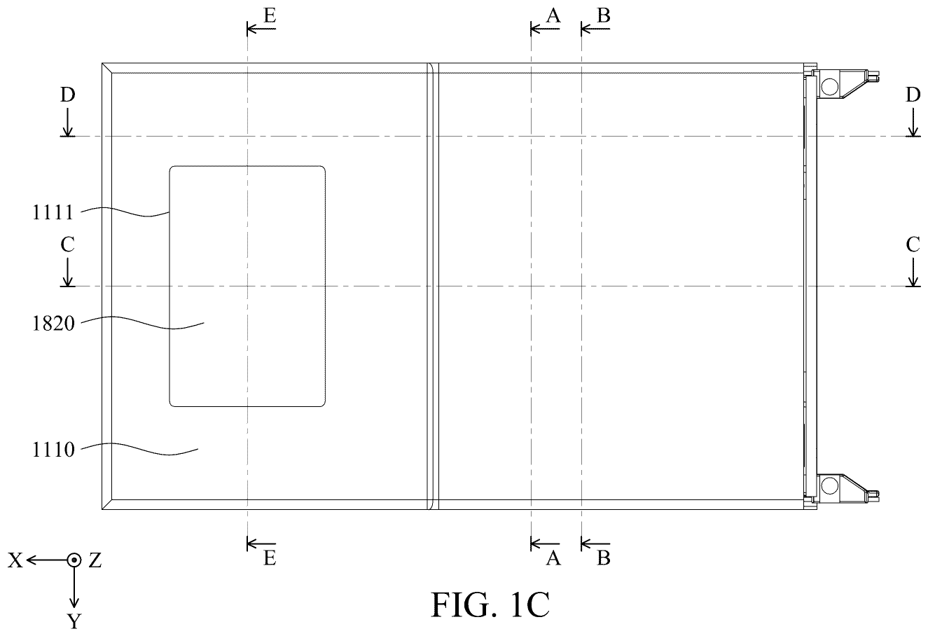

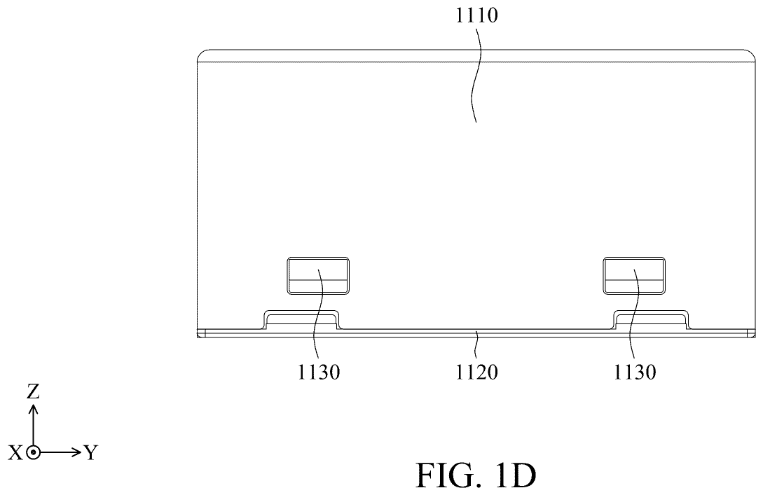

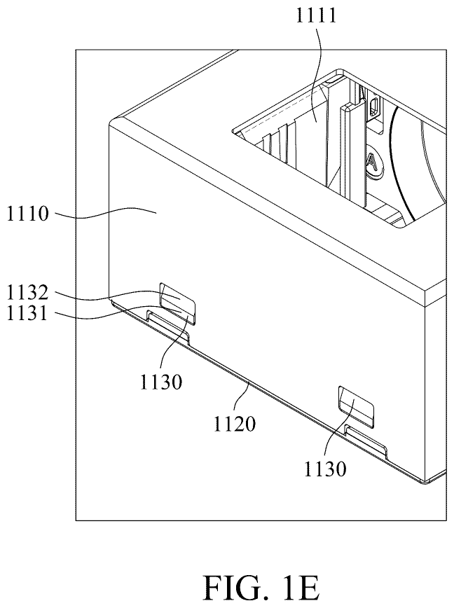

Embodiments of the present disclosure disclose an optical element driving mechanism used for driving an optical element to move. For example, For example, FIG. 1A is a schematic view of an optical element driving mechanism 1000. FIG. 1B is an exploded view of the optical element driving mechanism 1000. FIG. 1C is a top view of the optical element driving mechanism 1000. FIG. 1D is a side view of the optical element driving mechanism 1000. FIG. 1E is a schematic view of the optical element driving mechanism 1000.

As shown in FIG. 1A to FIG. 1E, the optical element driving mechanism 1000 may mainly include a fixed portion 1100 (including a case 1110, a bottom 1120), a first movable portion 1210, a second movable portion 1220, a first driving assembly 1310, a second driving assembly 1320, a connecting assembly 1400, a circuit element 1510, a resilient element 1520, an intermediate element 1530, and a first reinforcement element 1551, for driving a first optical element 1810 and a second optical element 1820 to move.

In some embodiments, the first optical element 1810 and the second optical element 1820 may be, for example, a lens, a mirror, a prism, a reflective polished surface, an optical coating, a beam splitter, an aperture, a liquid lens, an image sensor, a camera module, or a ranging module. It should be noted that the definition of the optical element is not limited to the element that is related to visible light, and other elements that relate to invisible light (e.g. infrared or ultraviolet) are also included in the present disclosure.

In some embodiments, the case 1110 and the bottom 1120 may be combined to form the shell of the optical element driving mechanism 1000, and other elements of the optical element driving mechanism 1000 may be disposed inside the shell formed by the case 1110 and the bottom 1120 to protect other elements. For example, the bottom 1120 may be affixed on the case 1110. The first optical element 1810 and the second optical element 1820 disposed in the optical element driving mechanism 1000 may perform focus on an image sensor (not shown). In some embodiments, the case 1110 may have an opening 1111 to expose a portion of the second optical element 1820 along the Z axis to allow light enter the optical element driving mechanism 1000 through the opening 1111 and reach the second optical element 1820. Afterwards, the second optical element 1820 may change the direction of the light, so that the light reaches the first optical element 1810, and then reaches the image sensor (not shown).

In some embodiments, the first movable portion 1210 and the second movable portion 1220 may be disposed in the fixed portion 1100 and are respectively used to connect the first optical element 1810 and the second optical element 1820. For example, the first movable portion 1210 may have a through hole, and the first optical element 1810 may be fixed in this through hole to allow the first optical element 1810 to move together with the first movable portion 1210 relative to the fixed portion 1100. The second optical element 1820 may also be disposed on the second movable portion 1220 and move together with the second movable portion 1220 relative to the fixed portion 1100. Additionally, the first optical element 1810 and the second optical element 1820 may also move relative to each other.

In some embodiments, the first driving assembly 1310 may be used to drive the first movable portion 1210 to move relative to the fixed portion 1100, and the second driving assembly 1320 may be used to drive the second movable portion 1220 to move relative to the fixed portion 1100 to achieve of auto focus (AF) or optical image stabilization (OIS).

In some embodiments, the connecting assembly 1400 may be disposed between the first movable portion 1210 and the fixed portion 1100 to movably connect the first movable portion 1210 to the fixed portion 1100.

In some embodiments, the circuit element 1510 may be a flexible printed circuit (FPC), the first driving assembly 1310 and the second driving assembly 1320 may be affixed on the circuit element 1510 through adhesion, and the circuit element 1510 may be disposed between the fixed portion 1100 and the first movable portion 1210.

In this embodiment, the circuit element 1510 is electrically connected to other electronic elements disposed inside or outside the optical element driving mechanism 1000 to control the movement of the first movable portion 1210 and the second movable portion 1220 along the X, Y, and Z axes for achieving of auto focus (AF) or optical image stabilization (OIS).

In some embodiments, the resilient element 1520 may include a metal material, and the intermediate element 1530 may have a spherical surface to movably connect the fixed portion 1100 and the second movable portion 1220. Therefore, the second movable portion 1220 and the second optical element 1820 disposed on the second movable portion 1220 may be moved relative to the fixed portion 1100.

In some embodiments, as shown in FIG. 1D and FIG. 1E, when viewed along the X axis, the bottom 1120 includes a protruding portion 1130 exposed from the case 1110. The protruding portion 1130 may include a first protruding portion surface 1131 and a second protruding portion surface 1132 exposed from the case 1110, and the slopes of the first protruding portion surface 1131 and the second protruding portion surface 1132 are different, which allows the case 1110 to be assembled more conveniently with the bottom 1120.

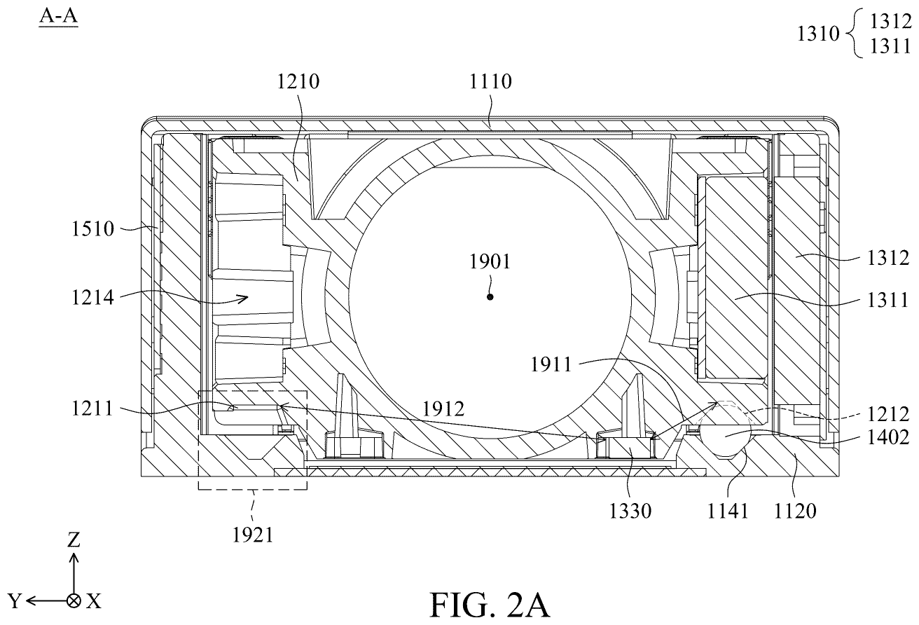

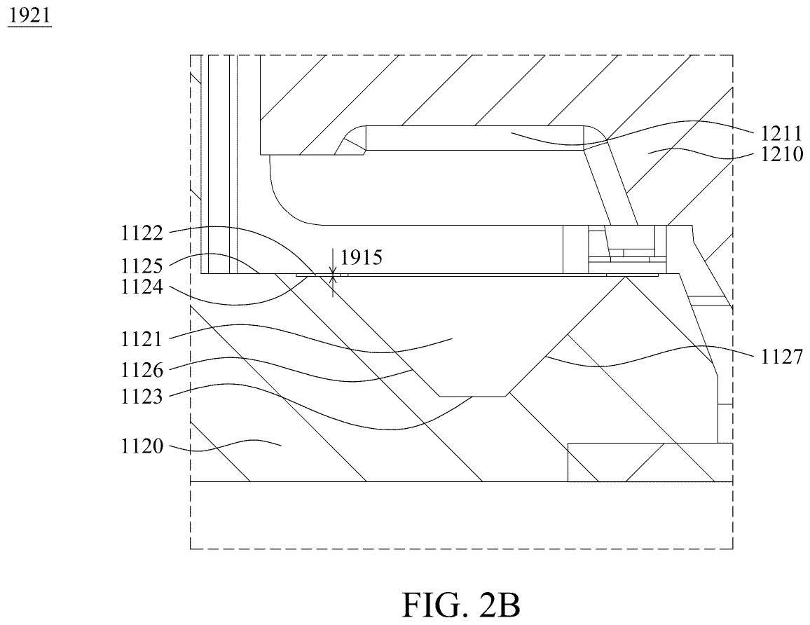

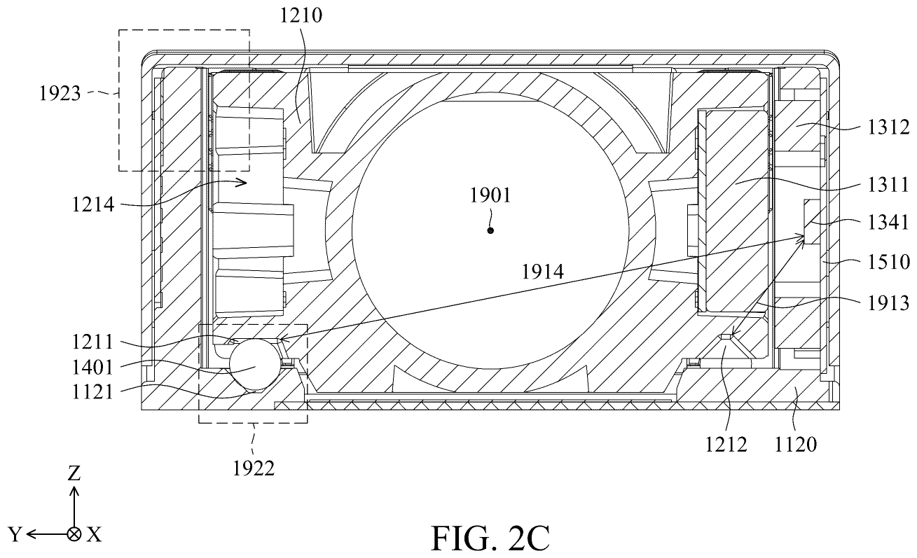

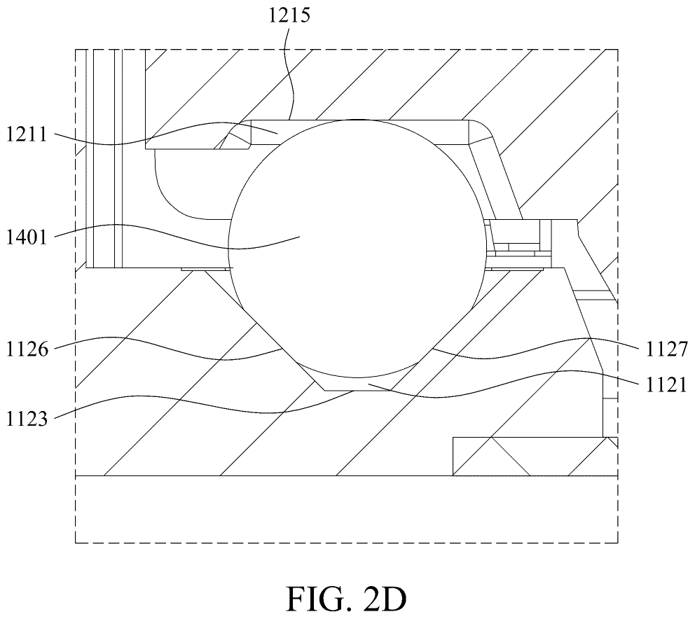

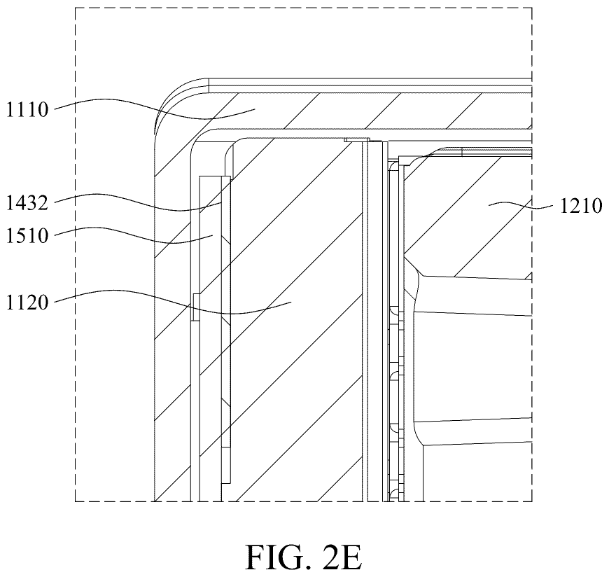

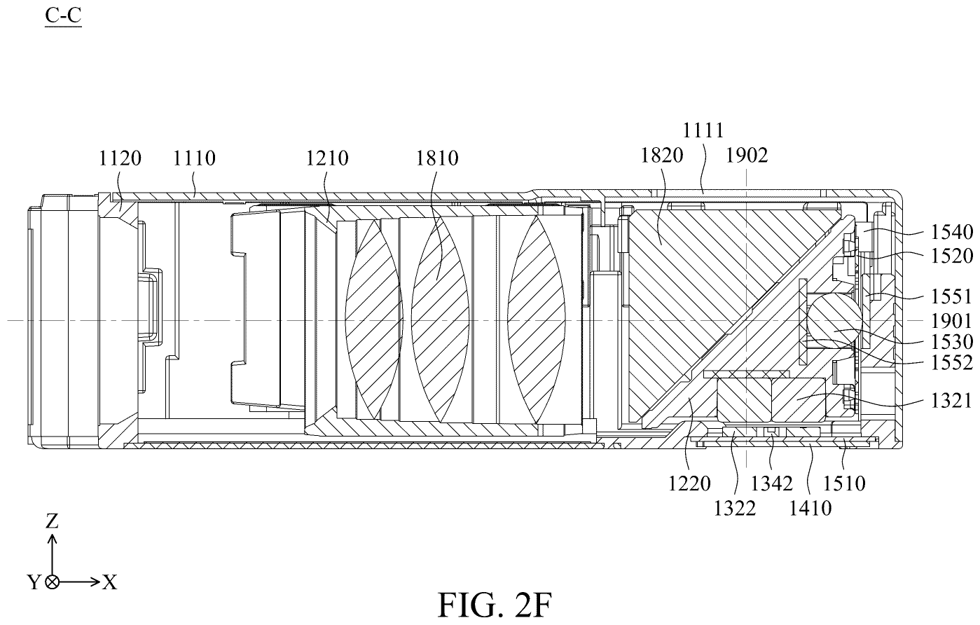

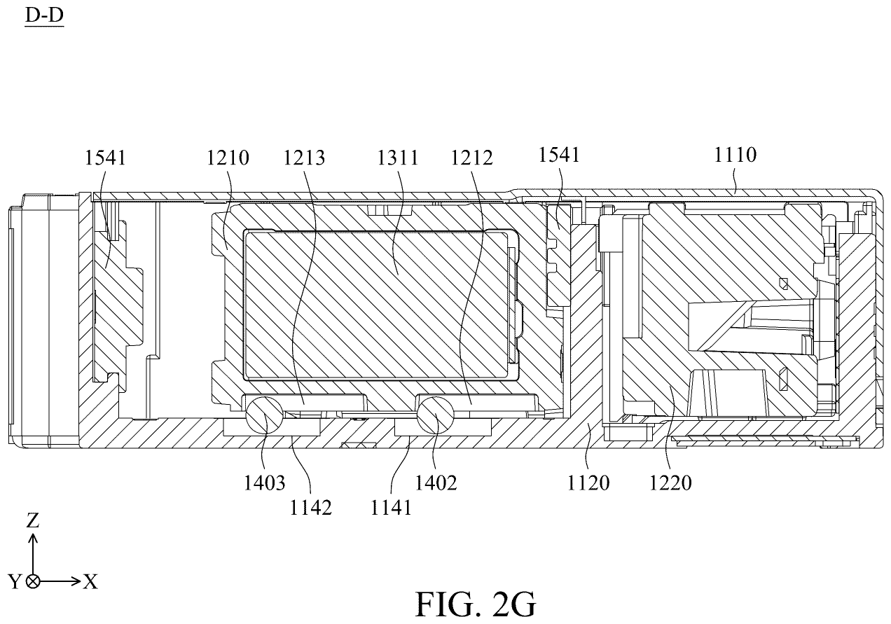

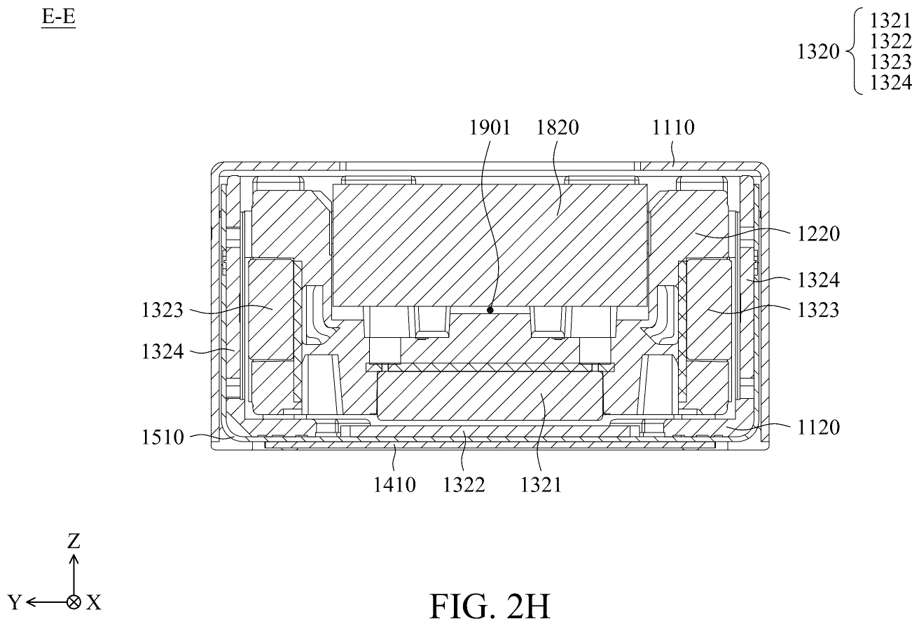

FIG. 2A is a cross-sectional view illustrated along a line A-A in FIG. 1C, and FIG. 2B is an enlarged view of an area 1921 in FIG. 2A. FIG. 2C is a cross-sectional view illustrated along line a B-B in FIG. 1C, and FIG. 2D is an enlarged view of an area 1922 in FIG. 2C. As shown in FIG. 2A to FIG. 2D, the bottom 1120 may include a first recessed portion 1121 and a second recessed portion 1122, and the first movable portion 1210 may include a third recessed portion 1211. The third recessed portion 1211 may be opposed to the first recessed portion 1121 and the second recessed portion 1122, such as at least partially overlapping each other on the Z axis, and may be used for accommodating the first connecting element 1401 of the connecting assembly 1400. In other words, the first connecting element 1401 may be disposed in the first recessed portion 1121 and the third recessed portion 1211 to movably connect the first movable portion 1210 and the fixed portion 1100 (e.g., the bottom 1120).

In some embodiments, the first recessed portion 1121 and the second recessed portion 1122 may be recessed from a first bottom surface 1125 of the bottom 1120, and the second recessed portion 1122 may surround the first recessed portion 1121. Specifically, the first recessed portion 1121 may have a first recessed portion bottom surface 1123, the second recessed portion 1122 may have a second recessed portion bottom surface 1124, and the first recessed portion bottom surface 1123, the second recessed portion bottom surface 1124, and the first bottom surface 1125 may be parallel to each other, such as all of them having a normal vector parallel to the Z axis.

In some embodiments, a gap 1915 may be provided between the first recessed portion bottom surface 1123 and the second recessed portion bottom surface 1124, the gap 1915 may be less than 0.1 mm and may be greater than 0 mm, such as 0.01 mm, 0.03 mm, etc. In some embodiments, a lubricating material (not shown) may be provided on each element of the connecting assembly 1400 (e.g., the first connecting element 1401) to reduce friction between the connecting assembly 1400 and the bottom 1120 and the first movable portion 1210, and the second recessed portion bottom surface 1124 may accommodate excess lubricating material to prevent overflow.

In some embodiments, the first recessed portion 1121 may further include a first side surface 1126 and a second side surface 1127 connecting the first recessed portion bottom surface 1123 and the second recessed portion bottom surface 1124, and the first connecting element 1401 may directly contact the first side surface 1126 and the second side surface 1127 without contacting the first recessed portion bottom surface 1123 and the second recessed portion bottom surface 1124. In some embodiments, the first side surface 1126 and the second side surface 1127 are not parallel to the first recessed portion bottom surface 1123. In some embodiments, the third recessed portion 1211 may have a third recessed portion bottom surface 1215 parallel to the first recessed portion bottom surface 1123 and directly contact the first connecting element 1401. By this configuration, the position of the first connecting element 1401 relative to the bottom 1120 in the Y direction may be fixed, and since the first movable portion 1210 only connects to the first connecting element 1401 via the third recessed portion bottom surface 1215, the position of the first movable portion 1210 relative to the first connecting element 1401 in the Y direction is adjustable to avoid the impact of production tolerances on the assembly of the elements.

FIG. 2E is an enlarged view of an area 1923 in FIG. 2C. As shown in FIG. 2E, a second adhesive element 1432 may be disposed between the circuit element 1510 and the bottom 1120 to affix the relative position of the circuit element 1510 and the bottom 1120.

FIG. 2F is a cross-sectional view illustrated along a line C-C of FIG. 1C. As shown in FIG. 2F, the first movable portion 1210 and the second movable portion 1220 may be arranged along the first axis 1901, the opening 1111 and the second optical element 1820 may be arranged along the second axis 1902, and the first axis 1901 and the second axis 1902 may not be parallel, such as may be perpendicular to each other. That is, when external light reaches the second optical element 1820 from the opening 1111 along the second axis 1902, the second optical element 1820 may change the direction of the light so that the light reaches the first optical element 1810 along the first axis 1901. Therefore, the size of the optical element driving mechanism 1000 along the second axis 1902 may be reduced to achieve miniaturization.

In some embodiments, the resilient element 1520 may be disposed between the second movable portion 1220 and the bottom 1120 to movably connect the second movable portion 1220 and the bottom 1120. A second reinforcement element 1552 may be disposed in the second movable portion 1220, such as embedded in the second movable portion 1220, and the second reinforcement element 1552 may have a material different from the second movable portion 1220. For example, the material of the second movable portion 1220 may include plastic, and the material of the second reinforcement element 1552 may include metal. The material of the first reinforcement element 1551 may further include metal.

In some embodiments, the intermediate element 1530 may be disposed between the first reinforcement element 1551 and the second reinforcement element 1552, and the intermediate element 1530 is movable relative to one of the first reinforcement element 1551 and the second reinforcement element 1552, and being affixed relative to the other. For example, the intermediate element 1530 may be fixed to the second reinforcement element 1552 and be movable relative to the first reinforcement element 1551, or fixed to the first reinforcement element 1551 and be movable relative to the second reinforcement element 1552, depending on design requirements. This allows the second movable portion 1220 to be movably connected to the fixed portion 1100 and reduces friction between the second movable portion 1220 and the fixed portion 1100. In some embodiments, the material of the intermediate element 1530 may include ceramic. In some embodiments, the hardness of the intermediate element 1530 may be greater than the hardness of the first reinforcement element 1551 and the second reinforcement element 1552 to provide better durability.

FIG. 2G is a cross-sectional view illustrated along a line D-D in FIG. 1C. As shown in FIG. 2A, FIG. 2C, and FIG. 2G, the first movable portion 1210 may further include a fourth recessed portion 1212 and a fifth recessed portion 1213, and the bottom 1120 may further include a sixth recessed portion 1141 and a seventh recessed portion 1142. The connecting assembly 1400 may further include a second connecting element 1402 and a third connecting element 1403, the second connecting element 1402 may be disposed in the fourth recessed portion 1212 and the sixth recessed portion 1141, and the third connecting element 1403 may be disposed in the fifth recessed portion 1213 and the seventh recessed portion 1142 to reduce friction when the first movable portion 1210 moves relative to the bottom 1120. Additionally, a second buffer element 1541 may be disposed between the first movable portion 1210 and the bottom 1120 to absorb impacts and reduce noise, and to protect the first movable portion 1210 from damage. The second buffer element 1541 may include a soft material.

As shown in FIG. 2A and FIG. 2C, when viewed along the X-axis, the shapes of the third recessed portion 1211 and the fourth recessed portion 1212 may be different from each other. For example, the fourth recessed portion 1212 may have a generally V-shaped cross-section, which may limit the position of the second connecting element 1402 relative to the first movable portion 1210 along the Y axis. On the contrary, the third recessed portion 1211 may allow the first connecting element 1401 to move relative to the first movable portion 1210 along the Y axis. The fifth recessed portion 1213 may also have a structure similar to the fourth recessed portion 1212, which will not be further described here.

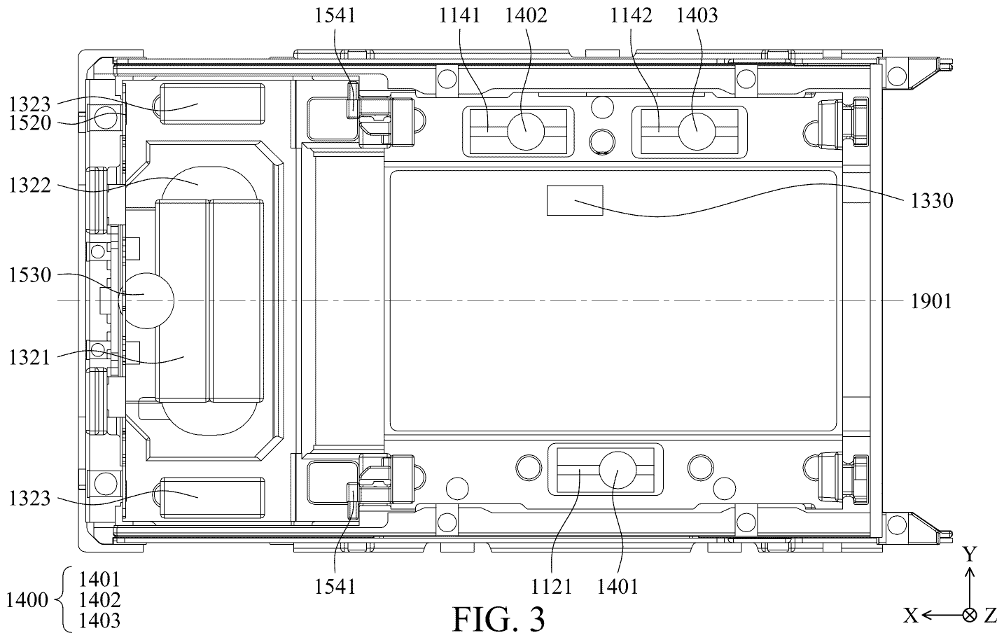

FIG. 2H is a cross-sectional view illustrated along a line E-E in FIG. 1C, and FIG. 3 is a schematic view of some elements of the optical element driving mechanism 1000. In some embodiments, as shown in FIG. 2H and FIG. 3, the first recessed portion 1121, the sixth recessed portion 1141, and the seventh recessed portion 1142 may be strip-shaped and may extend along the first axis 1901 (parallel to the X axis). The third recessed portion 1211, the fourth recessed portion 1212, and the fifth recessed portion 1213 may also extend along the first axis 1901. Additionally, since the first connecting element 1401, the second connecting element 1402, and the third connecting element 1403 are respectively disposed in the first recessed portion 1121, the sixth recessed portion 1141, and the seventh recessed portion 1142, and respectively disposed in the third recessed portion 1211, the fourth recessed portion 1212, and the fifth recessed portion 1213, this may allow the first movable portion 1210 to move relative to the fixed portion 1100 in the direction that the first axis 1901 extends to achieve auto focus. In some embodiments, as shown in FIG. 3, the resilient element 1520 and the second buffer element 1541 may at least partially overlap each other in the direction that the first axis 1901 extends to reduce the size of the optical element driving mechanism 1000 in other directions, thereby achieving miniaturization.

In some embodiments, as shown in FIG. 2A and FIG. 2C, the first driving assembly 1310 may include a first magnetic element 1311 and a first driving coil 1312 respectively disposed on the first movable portion 1210 and the bottom 1120, or their positions may be interchanged depending on design requirements. When power is provided to the first driving coil 1312, an electromagnetic force may be generated between the first magnetic element 1311 and the first driving coil 1312 to drive the first movable portion 1210 to move relative to the fixed portion 1100.

In some embodiments, as shown in FIG. 2H, the second driving assembly 1320 may include a second magnetic element 1321, a second driving coil 1322, a third magnetic element 1323, and a third driving coil 1324, wherein the second magnetic element 1321 and the third magnetic element 1323 may be disposed on the second movable portion 1220, and the second driving coil 1322 and the third driving coil 1324 may be disposed on the bottom 1120, or their positions may be interchanged depending on design requirements. When power is provided to the second driving coil 1322 and the third driving coil 1324, they may respectively generate electromagnetic forces with the second magnetic element 1321 and the third magnetic element 1323 to drive the second movable portion 1220 to move relative to the fixed portion 1100.

In some embodiments, as shown in FIG. 2C, a first sensing element 1341 may be disposed in the first driving coil 1312, and the first sensing element 1341 may be disposed on the circuit element 1510 to detect the magnetic field changes of the first magnetic element 1311 for obtaining the position of the first movable portion 1210 relative to the fixed portion 1100. In some embodiments, the first sensing element 1341 may include a Hall sensor, a magnetoresistance effect sensor (MR sensor), a giant magnetoresistance effect sensor (GMR sensor), a tunneling magnetoresistance effect sensor (TMR sensor), or a fluxgate sensor.

In some embodiments, as shown in FIG. 2A, the first movable portion 1210 may further include a first recessed structure 1214 partially overlapping the third recessed portion 1211 along the Z axis to reduce the weight of the first movable portion 1210. To balance both sides of the first movable portion 1210, in some embodiments, as shown in FIG. 2A and FIG. 3, an additional auxiliary magnetic element 1330 may be disposed on the fixed portion 1100 and adjacent to the first magnetic element 1311 to provide an attractive force for stabilizing the position of the first movable portion 1210 relative to the fixed portion 1100. In some embodiments, as shown in FIG. 2A and FIG. 2C, a distance 1911 between the auxiliary magnetic element 1330 and the fourth recessed portion 1212 is less than a distance 1912 between the auxiliary magnetic element 1330 and the third recessed portion 1211, and a distance 1913 between the first sensing element 1341 and the fourth recessed portion 1212 is less than a distance 1914 between the first sensing element 1341 and the third recessed portion 1211. In other words, the first sensing element 1341 and the auxiliary magnetic element 1330 may be closer to the fourth recessed portion 1212 to achieve better sensing and attracting performance.

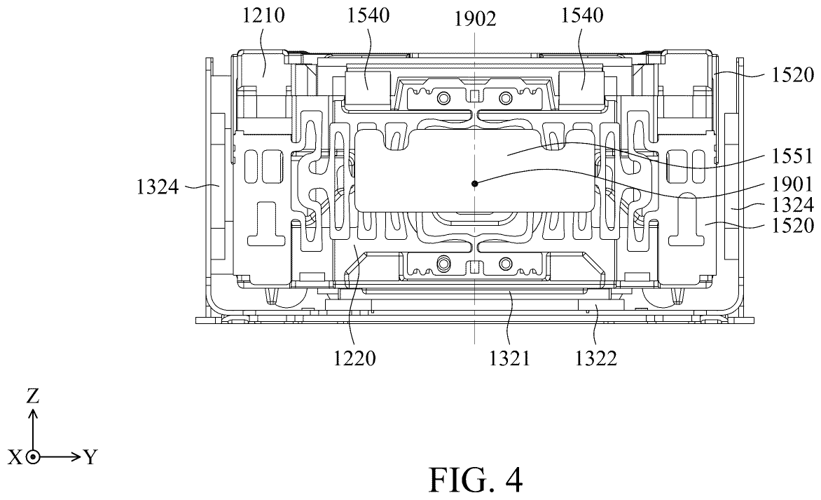

FIG. 4 is a schematic view of some elements of the optical element driving mechanism 1000. As shown in FIG. 2F and FIG. 4, the optical element driving mechanism 1000 may further include a first buffer element 1540 disposed between the fixed portion 1100 and the second movable portion 1220. The first buffer element 1540 may include a gel to absorb any abnormal vibrations that may occur when the second movable portion 1220 moves relative to the fixed portion 1100. Furthermore, the resilient element 1520 and the first buffer element 1540 do not overlap each other when viewed along the first axis 1901, and the resilient element 1520 and the first buffer element 1540 may at least partially overlap each other in the direction that the second axis 1902 extends to reduce the size in other directions, thereby achieving miniaturization.

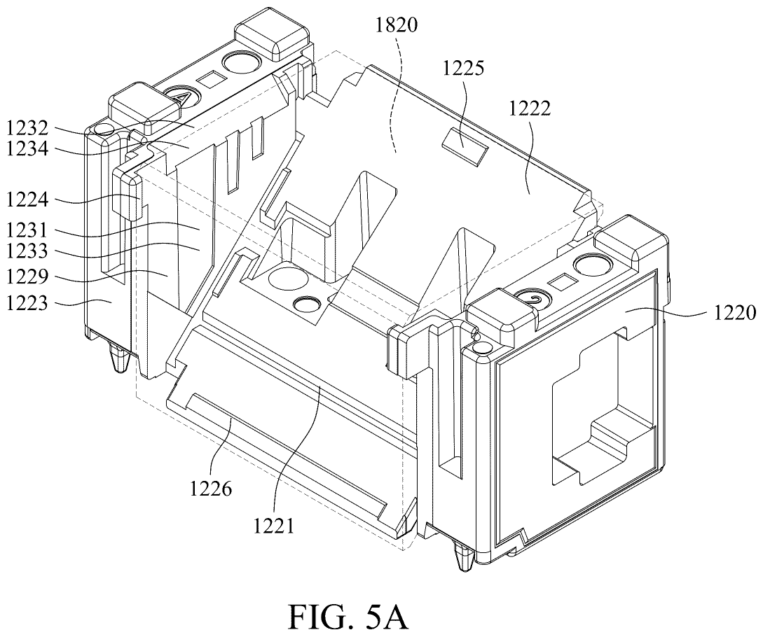

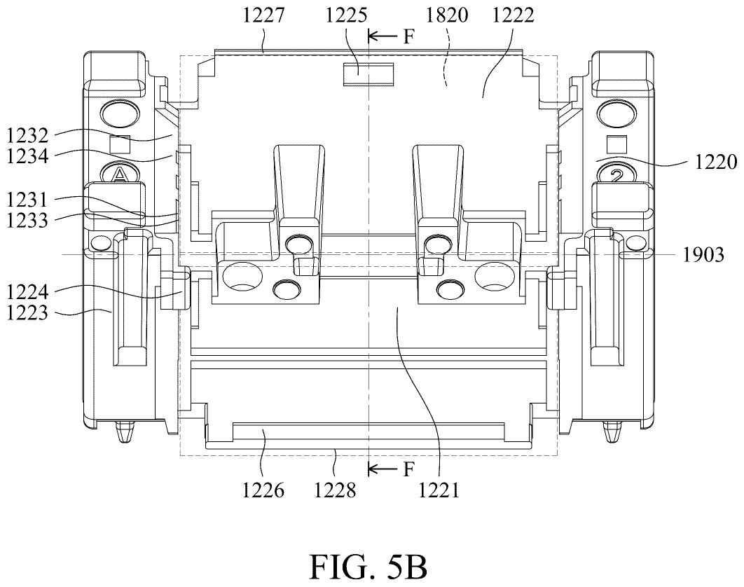

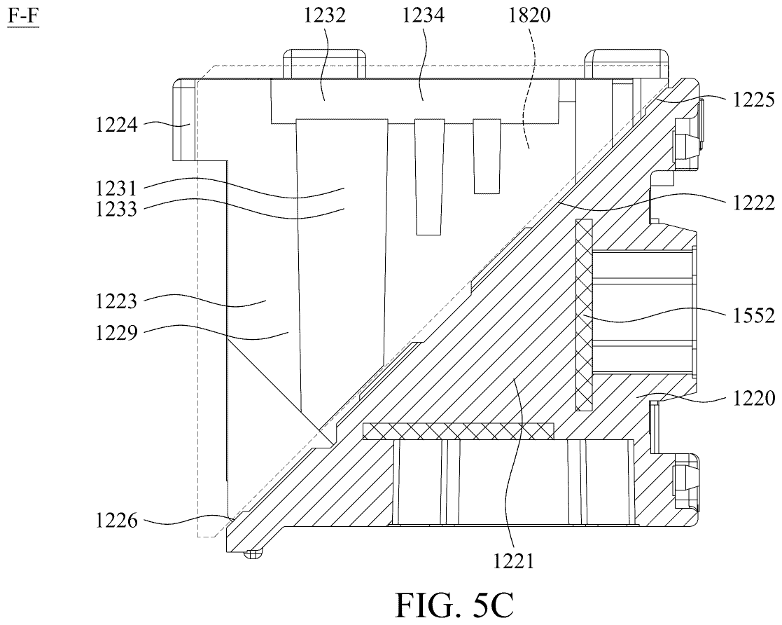

FIG. 5A and FIG. 5B are schematic views of the second movable portion 1220 and the second optical element 1820 viewed from different directions, and FIG. 5C is a cross-sectional view illustrated along a line F-F of FIG. 5B. As shown in FIG. 5A to FIG. 5C, the second movable portion 1220 may include a main body 1221 and a first sidewall 1223 extending from the main body 1221. The first sidewall 1223 may have a first supporting portion 1224, and a main body surface 1222 of the main body 1221 may face the second optical element 1820 and may have a second supporting portion 1225 and a third supporting portion 1226 protruding from the main body surface 1222.

The second optical element 1820 may in direct contact with the first supporting portion 1224, the second supporting portion 1225, and the third supporting portion 1226 to define the position of the second optical element 1820. In some embodiments, as shown in FIG. 5B, the first supporting portion 1224 may extend along the third axis 1903, wherein the third axis 1903 may be non-parallel to the first axis 1901 and the second axis 1902, such as they may be perpendicular to each other.

In some embodiments, as shown in FIG. 5C, the main body surface 1222 of the main body 1221 may have an inclined surface, and when the second optical element 1820 is placed on the second movable portion 1220, the second optical element 1820 will slide downward due to gravity until the second optical element 1820 abuts the first supporting portion 1224, which defines the position of the second optical element 1820 relative to the second movable portion 1220. In some embodiments, as shown in FIG. 5B, the second supporting portion 1225 and the third supporting portion 1226 may be strip-shaped and may extend along the third axis 1903. Specifically, the second supporting portion 1225 may be located on a middle section of a first side 1227 of the main body surface 1222, and the third supporting portion 1226 may be located on a second side 1228 of the main body surface 1222 The first side 1227 and the second side 1228 are located on opposite sides of the main body surface 1222.

Additionally, the first sidewall 1223 may further include a first recess 1231 and a second recess 1232, and the first recess 1231 may be adjacent to the second recess 1232. The first recess 1231 and the second recess 1232 may each have a first recess surface 1233 and a second recess surface 1234 adjacent to each other. The first recess 1231 and the second recess 1232 may be recessed from a first sidewall surface 1229 of the first sidewall 1223, the first recess surface 1233 and the second recess surface 1234 are not parallel to the first sidewall surface 1229, and the first recess surface 1233 and the second recess surface 1234 are not parallel to each other, such as the first recess surface 1233 and the second recess surface 1234 may have different slopes.

In some embodiments, adhesive elements (not shown) may be provided in the first recess 1231 and the second recess 1232, such as UV-curable adhesive, thermal-curable adhesive, moisture-curable adhesive, AB adhesive (such as acrylic, epoxy, polyurethane, etc.), but it is not limited thereto. When the adhesive element is provided to the second recess 1232, the adhesive element may flow along the first recess 1231 between the second movable portion 1220 and the second optical element 1820 to fix the second optical element 1820 to the second movable portion 1220. By designing the first recess 1231 and the second recess 1232, the adhesive area between the adhesive element and the second movable portion 1220 may be increased to enhance the bonding strength.

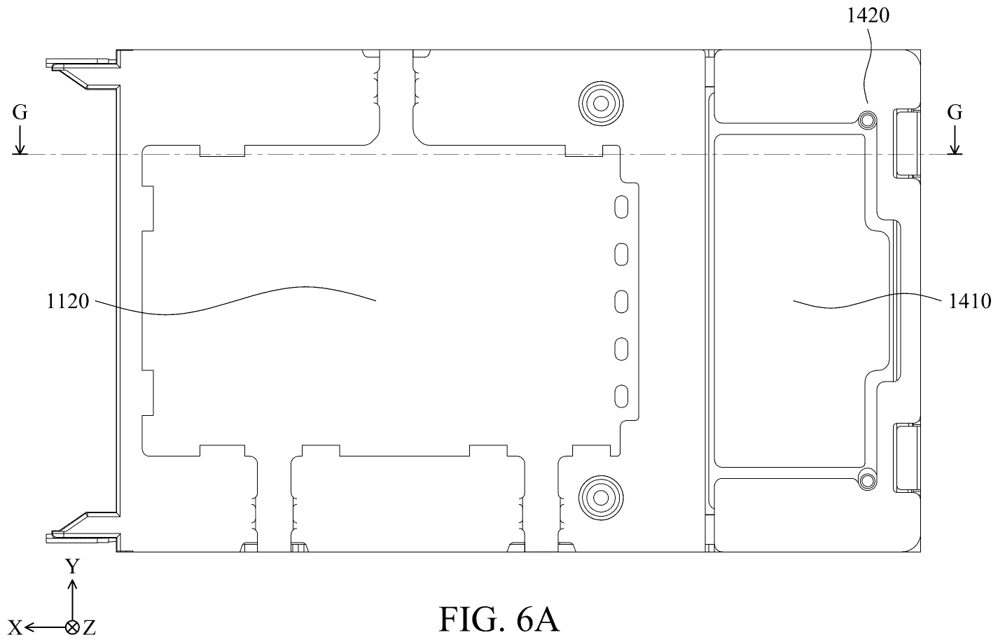

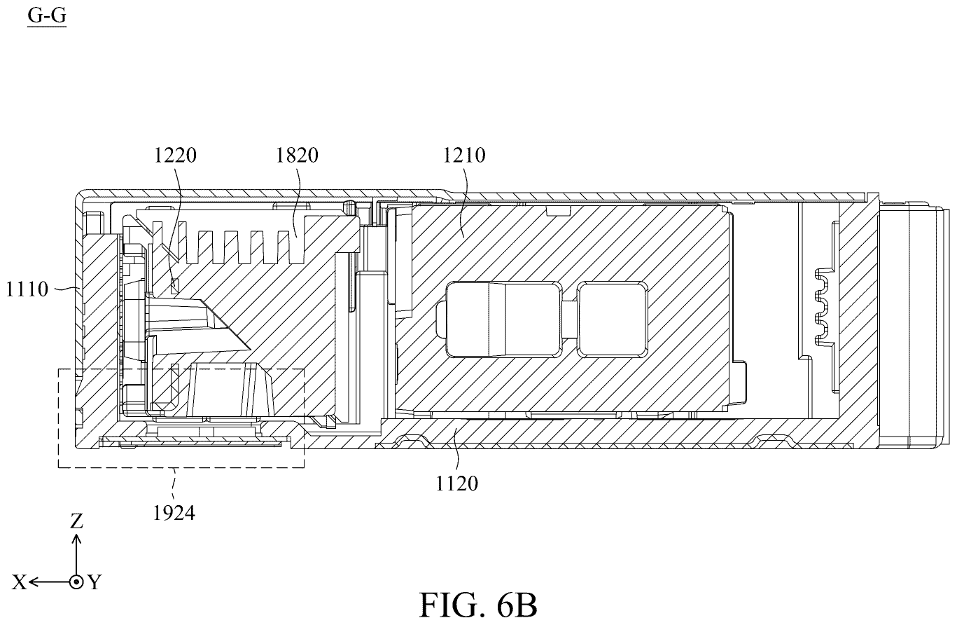

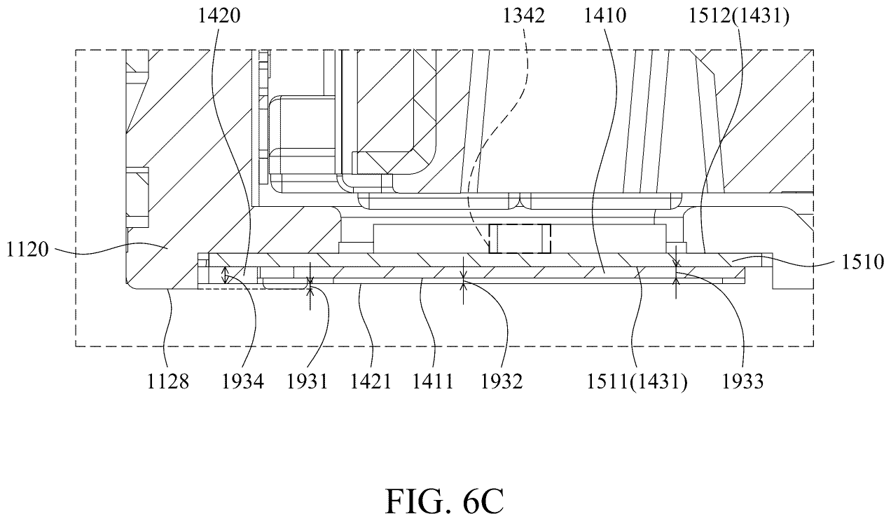

FIG. 6A is a bottom view of the optical element driving mechanism 1000, FIG. 6B is a cross-sectional view illustrated along a line G-G of FIG. 6A, and FIG. 6C is an enlarged view of an area 1924 of FIG. 6B. As shown in FIG. 6A to FIG. 6C, the optical element driving mechanism 1000 may further include a first reinforcement element 1410 and a second reinforcement element 1420 disposed on the bottom surface of the bottom 1120 to protect specific elements.

As shown in FIG. 6C, in some embodiments, the first reinforcement element 1410 may have a first reinforcement element surface 1411, the second reinforcement element 1420 may have a second reinforcement element surface 1421, and the bottom 1120 may have a second bottom surface 1128. The second bottom surface 1128, the first reinforcement element surface 1411, and the second reinforcement element surface 1421 may be parallel to each other and face an identical direction, but located on different planes. Specifically, in a direction that the second axis 1902 extends (Z direction), a first height difference 1931 is between the second bottom surface 1128 and the second reinforcement element surface 1421, a second height difference 1932 is between the first reinforcement element surface 1411 and the second reinforcement element surface 1421, and the first height difference 1931 and the second height difference 1932 are greater than 0. The second reinforcement element surface 1421 is located between the second bottom surface 1128 and the first reinforcement element surface 1411.

In some embodiments, as shown in FIG. 2F and FIG. 6C, a second sensing element 1342 may be disposed in the second driving coil 1322 to detect the magnetic field of the second magnetic element 1321 for obtaining the position of the second movable portion 1220 relative to the fixed portion 1100. In some embodiments, in the direction that the second axis 1902 extends, the second sensing element 1342 and the first reinforcement element 1410 may at least partially overlap each other to allow using the first reinforcement element 1410 to protect the second sensing element 1342 from receiving external impacts. In some embodiments, the first reinforcement element 1410 and the second reinforcement element 1420 are disposed on the circuit element 1510. The second reinforcement element 1420 may be affixed to the case 1110, such as by laser welding. The second sensing element 1342 may include the same or similar sensing elements as the aforementioned first sensing element 1341, which will not be described again.

In some embodiments, the first reinforcement element 1410 and the second reinforcement element 1420 may include different materials, such as different metals. In some embodiments, the first reinforcement element 1410 and the second reinforcement element 1420 may have different magnetic permeability coefficients, such as the magnetic permeability coefficient of the first reinforcement element 1410 may be greater than that of the second reinforcement element 1420. This can prevent the second sensing element 1342 from being affected by external magnetic interference.

In some embodiments, the first reinforcement element 1410 may have a first thickness 1933, the second reinforcement element 1420 may have a second thickness 1934, and the first thickness 1933 and the second thickness 1934 may be different, such as the first thickness 1933 may be less than the second thickness 1934. In some embodiments, as shown in FIG. 6A, when viewed along the second axis 1902, the first reinforcement element 1410 and the second reinforcement element 1420 do not overlap each other to reduce the size along the Z axis, and thus achieve miniaturization.

In some embodiments, the circuit element 1510 may include a first circuit element surface 1511 and a second circuit element surface 1512 opposite each other and facing the first reinforcement element 1410 and the bottom 1120, respectively. For example, the first circuit element surface 1511 may directly contact the first reinforcement element 1410 and the second reinforcement element 1420, and the second circuit element surface 1512 directly contacts the bottom 1120. The first adhesive element 1431 may be disposed on both of the first circuit element surface 1511 and the second circuit element surface 1512 to fix the circuit element 1510 with other elements.

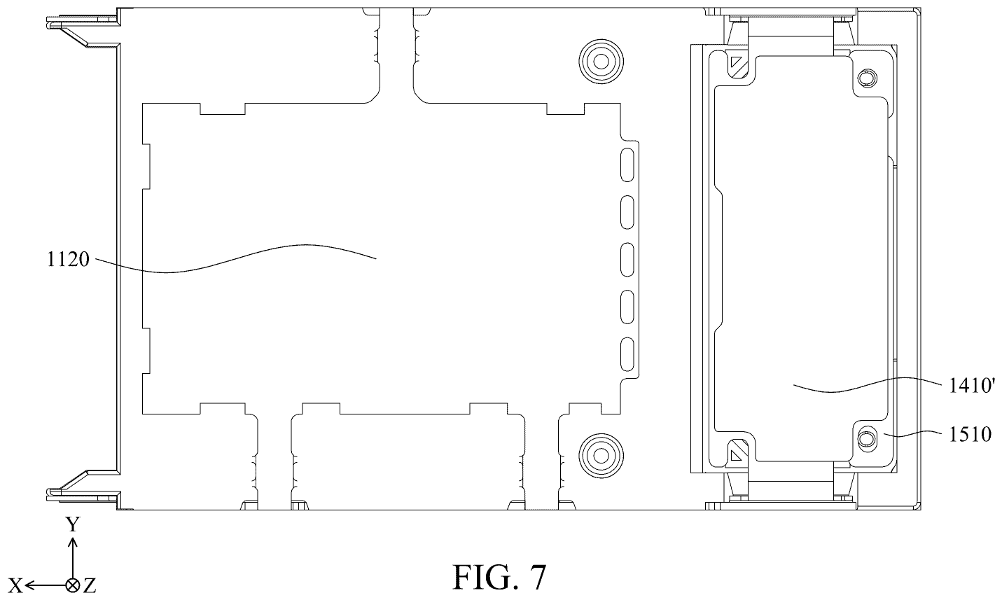

Although the previous embodiments disclose embodiments including the first reinforcement element 1410 and the second reinforcement element 1420, the present disclosure is not limited thereto. For example, FIG. 7 is a bottom view of another embodiment of the optical element driving mechanism of this disclosure, which includes a first reinforcement element 1410′ without the second reinforcing element, depending on design requirements.

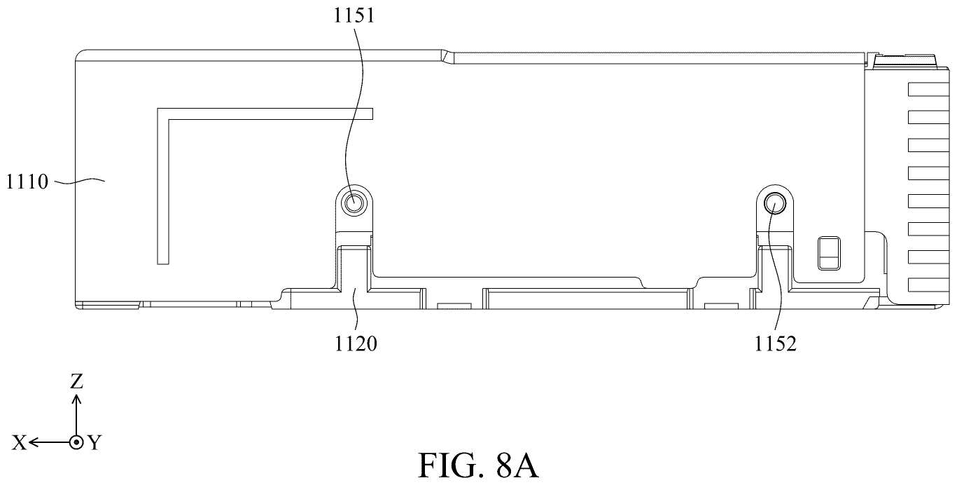

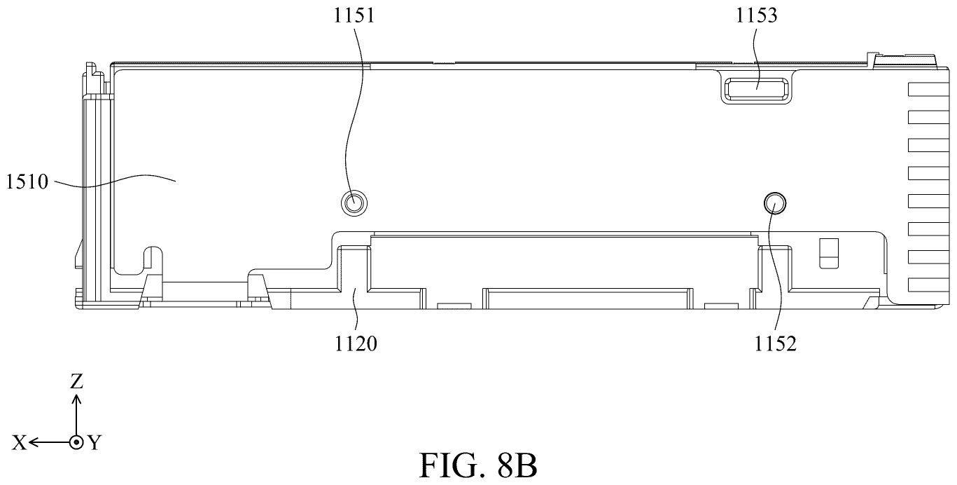

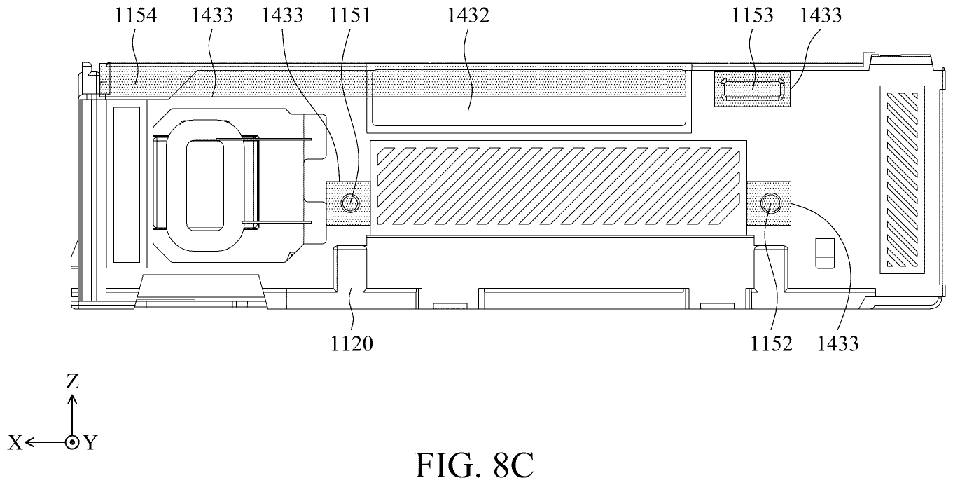

FIG. 8A, FIG. 8B, and FIG. 8C are schematic views of some elements of the optical element driving mechanism 1000, which show different elements to further describe the positional relationship between the elements. As shown in FIG. 8A to FIG. 8C, when viewed along the third axis 1903, the bottom 1120 may include a first positioning element 1151, a second positioning element 1152, a third positioning element 1153, and a second recessed structure 1154, and the optical element driving mechanism 1000 may further include a second adhesive element 1432 and a third adhesive element 1433. The second adhesive element 1432 is disposed between the circuit element 1510 and the bottom 1120, and the third adhesive element 1433 may be disposed in the second recessed structure 1154 and may directly contact the first positioning element 1151, the second positioning element 1152, and the third positioning element 1153.

In some embodiments, the second adhesive element 1432 and the third adhesive element 1433 may include different materials, such as initially fixing the bottom 1120 and other elements by the second adhesive element 1432, and then further fixing them by the third adhesive element 1433. The first positioning element 1151, the second positioning element 1152, and the third positioning element 1153 may protrude from a side of the bottom 1120, and the second recessed structure 1154 may be disposed at a corner of the bottom 1120 to accommodate excess third adhesive element 1433.

In some embodiments, when viewed along the third axis 1903, as shown in FIG. 8B, the circuit element 1510 does not overlap the first positioning element 1151, the second positioning element 1152, and the third positioning element 1153. For example, the circuit element 1510 may have corresponding recesses or openings to the first positioning element 1151, the second positioning element 1152, and the third positioning element 1153, so the position of the circuit element 1510 relative to the bottom 1120 may be located by the first positioning element 1151, the second positioning element 1152, and the third positioning element 1153 during assembly. Furthermore, as shown in FIG. 8A, when viewed along the third axis 1903, the first positioning element 1151 and the second positioning element 1152 may also not overlap the case 1110, and the third positioning element 1153 at least partially overlaps the case 1110. In other words, the first positioning element 1151 and the second positioning element 1152 may be exposed from the case 1110.

With the design of various embodiments of the present disclosure, a single fixed portion 1100 may correspond to two different first movable portion 1210 and second movable portion 1220. For example, the first movable portion 1210 and the second movable portion 1220 may be disposed between the case 1110 and the bottom 1120 to reduce the number of parts in the optical element driving mechanism 1000 and making the assembly process faster.

In summary, an optical element driving mechanism is provided, which includes a fixed portion, a first movable portion, and a driving assembly. The first movable portion is used for connecting to a first optical element. The first movable portion is movable relative to the fixed portion. The first driving assembly is used for driving the first movable portion to move relative to the fixed portion. Therefore, auto focus, optical image stabilization, and focus change may be performed, and miniaturization may be achieved as well.

The relative positions and size relationship of the elements in the present disclosure may allow the driving mechanism achieving miniaturization in specific directions or for the entire mechanism. Moreover, different optical modules may be combined with the driving mechanism to further enhance optical quality, such as the quality of photographing or accuracy of depth detection. Therefore, the optical modules may be further utilized to achieve multiple anti-vibration systems, so image stabilization may be significantly improved.

Although embodiments of the present disclosure and their advantages already have been described in detail, it should be understood that various changes, substitutions and alterations may be made herein without departing from the spirit and the scope of the disclosure as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are also intended to include within their scope of such processes, machines, manufacture, and compositions of matter, means, methods, or steps. In addition, each claim herein constitutes a separate embodiment, and the combination of various claims and embodiments are also within the scope of the disclosure.

1-20. (canceled)

21. An optical element driving mechanism, comprising:
a fixed portion;
a first movable portion used for connecting a first optical element and movable relative to the fixed portion; and
a first driving assembly used for driving the first movable portion to move relative to the fixed portion.

22. The optical element driving mechanism as claimed in claim 21, further comprising a connecting assembly, wherein:
the fixed portion comprises a bottom;
the bottom comprises a first recessed portion, a second recessed portion, and a first bottom surface;
the first recessed portion and the second recessed portion are recessed from the first bottom surface;
the first recessed portion comprises a first recessed portion bottom surface;
the second recessed portion comprises a second recessed portion bottom surface;
the second recessed portion surrounds the first recessed portion;
the first recessed portion bottom surface and the second recessed portion bottom surface are parallel;
the first bottom surface and the second recessed portion bottom surface are parallel;
a gap is between the first bottom surface and the second recessed portion bottom surface;
the gap is less than 0.1 mm.

23. The optical element driving mechanism as claimed in claim 22, wherein:
the first recessed portion further comprises a first side surface and a second side surface;
the first side surface and the second side surface are not parallel;
the first side surface and the first recessed portion bottom surface are not parallel;
the second side surface and the first recessed portion bottom surface are not parallel.

24. The optical element driving mechanism as claimed in claim 23, wherein:
the connecting assembly comprises a first connecting element;
the first movable portion comprises a third recessed portion;
the first connecting element is disposed in the first recessed portion and the third recessed portion;
the third recessed portion comprises a third recessed portion bottom surface;
the third recessed portion bottom surface is parallel to the first recessed portion bottom surface;
the first connecting element is in direct contact with the first side surface, the second side surface, and the third recessed portion bottom surface;
the first connecting element and the first recessed portion bottom surface are separated from each other.

25. The optical element driving mechanism as claimed in claim 24, wherein:
the first movable portion further comprises a fourth recessed portion, a fifth recessed portion, and a first recessed structure;
the connecting assembly further comprises a second connecting element and a third connecting element;
the bottom further comprises a sixth recessed portion and a seventh recessed portion;
the second connecting element is disposed in the fourth recessed portion and the sixth recessed portion;
the third connecting element is disposed in the fifth recessed portion and the seventh recessed portion.

26. The optical element driving mechanism as claimed in claim 25, further comprising a first sensing element and an auxiliary magnetic element disposed on the fixed portion;
wherein:
a distance between the first sensing element and the fourth recessed portion is less than a distance between the first sensing element and the third recessed portion;
a distance between the auxiliary magnetic element and the fourth recessed portion is less than a distance between the auxiliary magnetic element and the third recessed portion.

27. The optical element driving mechanism as claimed in claim 26, wherein:
the fixed portion further comprises a case;
the case comprises an opening;
the optical element driving mechanism further comprises a second movable portion, a resilient element, a first buffer element, and a second buffer element;
the resilient element is disposed between the fixed portion and the second movable portion;
the first buffer element is disposed between the fixed portion and the second movable portion;
the second buffer element is disposed between the fixed portion and the first movable portion.

28. The optical element driving mechanism as claimed in claim 27, wherein:
the first movable portion and the second movable portion are arranged along a first axis;
a second axis is perpendicular to the first axis;
the resilient element and the first buffer element at least partially overlap each other in a direction that the second axis extends;
the first recessed structure and the third recessed portion at least partially overlap each other in the direction that the second axis extends;
the resilient element and the first buffer element do not overlap each other when viewed along the first axis;
the resilient element and the second buffer element at least partially overlap each other in a direction that the first axis extends.

29. The optical element driving mechanism as claimed in claim 28, wherein:
the second movable portion is used for connecting a second optical element;
the second movable portion comprises a main body and a first sidewall;
the sidewall extends from the main body;
the first sidewall comprises a first recess, a second recess, and a first supporting portion;
the first recess is adjacent to the second recess;
the first recess comprises a first recess surface;
the second recess comprises a second recess surface;
the first recess surface is adjacent to the second recess surface;
the first recess surface and the second recess surface are not parallel.

30. The optical element driving mechanism as claimed in claim 29, wherein:
the first recess surface and the second recess surface have different slopes;
the first supporting portion extends from the first sidewall along a third axis;
the third axis is not parallel to the first axis;
the third axis is not parallel to the second axis.

31. The optical element driving mechanism as claimed in claim 30, wherein:
the main body comprises a main body surface, a second supporting portion, and a third supporting portion;
the main body surface faces the second optical element;
the second supporting portion extends from the main body surface;
the third supporting portion extends from the main body surface.

32. The optical element driving mechanism as claimed in claim 31, wherein:
the second supporting portion extends along the third axis;
the third supporting portion extends along the third axis.

33. The optical element driving mechanism as claimed in claim 32, wherein:
the second supporting portion is at a first side of the main body surface;
the third supporting portion is at a second side of the main body surface;
the first side and the second side are opposite;
the third axis is perpendicular to the first axis;
the third axis is perpendicular to the second axis.

34. The optical element driving mechanism as claimed in claim 33, wherein:
the fixed portion further comprises a first reinforcement element and a second reinforcement element disposed on the bottom;
the bottom further comprises a second bottom surface;
the first reinforcement element comprises a first reinforcement element surface;
the second reinforcement element comprises a second reinforcement element surface;
the first reinforcement element surface is parallel to the second reinforcement element surface;
the first reinforcement element surface is parallel to the second bottom surface.

35. The optical element driving mechanism as claimed in claim 34, wherein:
a first height difference is between the second bottom surface and the second reinforcement element surface in the direction that the second axis extends;
a second height difference is between the first reinforcement element surface and the second reinforcement element surface in the direction that the second axis extends;
the first height difference and the second height difference are greater than zero;
the second reinforcement element surface is between the second bottom surface and the first reinforcement element surface;
the second supporting portion is at a middle section of the first side.

36. The optical element driving mechanism as claimed in claim 35, further comprising a second sensing element, wherein:
the second sensing element and the first reinforcement at least partially overlap each other in the direction that the second axis extends;
materials of the first reinforcement element and the second reinforcement element are different;
magnetic permeability coefficients of the first reinforcement element and the second reinforcement element are different.

37. The optical element driving mechanism as claimed in claim 36, wherein:
the first reinforcement element has a first thickness;
the second reinforcement element has a second thickness;
the first thickness and the second thickness are different;
the first reinforcement element and the second reinforcement element do not overlap each other when viewed along the second axis;
the second reinforcement element is welded to the case.

38. The optical element driving mechanism as claimed in claim 37, further comprising a circuit element and a first adhesive element, wherein:
the circuit element comprises a first circuit element surface and a second circuit element surface;
the first circuit element surface is in direct contact with the first reinforcement element and the second reinforcement element;
the second circuit element surface is in direct contact with the bottom;
the first circuit element surface and the second circuit element surface are opposite;
the first adhesive element is disposed on the first circuit element surface and the second circuit element surface;
the magnetic permeability coefficient of the first reinforcement element is greater than the magnetic permeability coefficient of the second reinforcement element;
the first thickness is less than the second thickness.

39. The optical element driving mechanism as claimed in claim 38, wherein:
the bottom comprises a second recessed structure, a first positioning element, a second positioning element, and a third positioning element;
the optical element driving mechanism further comprises a second adhesive element and a third adhesive element;
the second adhesive element is disposed between the bottom and the circuit element;
the third adhesive element is disposed in the second recessed structure;
the third adhesive element is in direct contact with the first positioning element;
the third adhesive element is in direct contact with the second positioning element;
the third adhesive element is in direct contact with the third positioning element;
the third adhesive element is in direct contact with the second adhesive element.

40. The optical element driving mechanism as claimed in claim 39, wherein:
the circuit element does not overlap the first positioning element, the second positioning element, and the third positioning element when viewed along the third axis;
the case does not overlap the first positioning element and the second positioning element when viewed along the third axis;
the case at least partially overlaps the third positioning element when viewed along the third axis;
the bottom further comprises a protruding portion exposed from the case when viewed along the first axis;
the protruding portion comprises a first protruding portion surface and a second protruding portion surface, and the first protruding portion surface and the second protruding portion surface are exposed from the case;
slopes of the first protruding portion surface and the second protruding portion surface are different.
